(19) United States
(12) Patent Application Publication
(10) Pub. No.: US 2011/0216670 A1
(43) Pub. Date: Sep. 8, 2011

(54) METHOD FOR DETERMINING NETWORK TOPOLOGY

(76) Inventors: Pradeep SRIRANGANATH, Bangalore (IN); Karthikeyan Senthilkumar, Bangalore (IN); Shivalingappa Ashoka, Bangalore (IN)

(21) Appl. No.: 13/028,233

(22) Filed: Feb. 16, 2011

(30) Foreign Application Priority Data
Mar. 3, 2010 (IN) 555/CHE/2010

(51) Int. Cl. H04L 12/28

(52) U.S. Cl. 370/255

(57) ABSTRACT

Presented is a method of determining network topology. The method includes determining virtual local area networks (VLANs) configured to at least one switch on a computer network, selecting a VLAN from the configured VLANs, determining state of the selected VLAN, determining ports associated with the selected VLAN, based upon the state of the selected VLAN, selecting a port from the associated ports, determining operational status of the selected port, and defining status of the selected VLAN, based upon the operational status of the selected port.

### BACKGROUND

A VLAN (Virtual Local Area Network) is a logical LAN (local area network) that extends beyond a single LAN to a group of LANs. Virtual LANs may be envisioned as a group of devices on different physical LAN segments which can communicate with each other as if they are all on the same physical LAN segment. Virtual LANs are also basically Layer 2 constructs. The Data Link Layer or Layer 2 of the seven-layer OSI model allows multiple LAN broadcast domains using the IEEE 802.1Q protocol.

Switches are ideally suited for a VLAN implementation. They allow a network to be divided into smaller, layer 2 segments, without the latency problems associated with a router. Large enterprises are increasingly deploying Layer 2 switches for high-speed connectivity between end stations at the data link layer. For a network administrator managing a large network, VLANs configured on a network switch (or multiple switches) may offer useful and vital information on network topology of the connected devices and state of the Layer 2 network connectivity.

### BRIEF DESCRIPTION OF THE DRAWINGS

For a better understanding of the invention, embodiments will now be described, purely by way of example, with reference to the accompanying drawings, in which:

FIG. 1 shows a flow chart of a method for determining network topology according to an embodiment

FIG. 2 shows an illustration of an exemplary graphical user interface (GUI) view of a list of VLANs configured on a switch including default VLANs according to an embodiment.

FIG. 3 shows an illustration of an exemplary graphical user interface (GUI) view of query results for all the VLANs listed in FIG. 2 according to an embodiment.

FIG. 4 shows an illustration of an exemplary graphical user interface (GUI) view of port results for all the VLANs listed in FIG. 2 according to an embodiment.

FIG. 5 shows an illustration of an exemplary graphical user interface (GUI) view of query results on operational status for all the VLANs listed in FIG. 2 according to an embodiment.

FIG. 6 shows an illustration of an exemplary graphical user interface (GUI) view of a cross reference for all the MIB attributes of a user configured VLANs and the computation of dynamic status of VLAN to be used for determining layer 2 connectivity according to an embodiment.

FIG. 7 shows a block diagram of a computer system upon which an embodiment may be implemented.

### DETAILED DESCRIPTION OF THE INVENTION

In the present scenario of a network management system (NMS), deriving layer 2 connectivity information is relied upon either by private management information base (MIB) implementations of the vendor or by standard Bridge-MIB. For example, in the Cisco switches that support VLAN, the standard BRIDGE-MIB is implemented using VLAN indexed community string in order to provide access for every instance of the BRIDGE-MIB for each VLAN in the switch. These instances of BRIDGE-MIB form the vital information for the management system to compute the network topology of the devices. The CISCO-VTP-MIB provides a MIB attribute, vtpVlanState, that presents the status of the configured VLANs, however it does not provide a dynamic status of VLANs at the real-time scenario. Further, if all the instances of the BRIDGE-MIB for the VLANs configured on the switch are queried irrespective of the dynamic status of the VLANs, the system may be rendered inefficient and give rise to possibilities of authentication traps arising out of querying VLANs that are operationally down.

Embodiments of the present invention provide a method to determine the dynamic status of VLANs configured on a network switch (or multiple switches) thereby selecting only those VLANs for the computation of the connectivity in a NMS.

For clarity and convenience, the following definition is used herein:

The term “network topology” refers to both physical and logical arrangement of elements in a computer network.

The embodiments of the present invention provide methods, computer executable code and a graphical user interface for determining network topology.

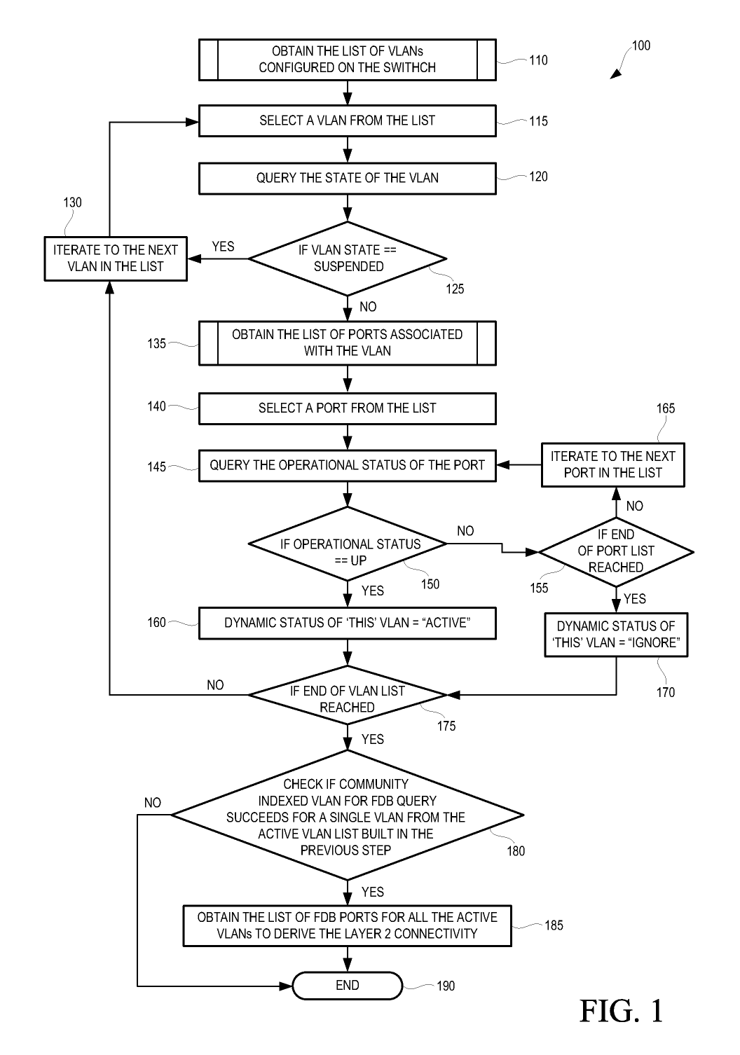

FIG. 1 shows a flow chart of a method 100 for determining network topology according to an embodiment. The method 100 may be performed with respect to one or more switches on a computer network.

In step 210, VLANs configured to at least one switch on a network are determined and a list of configured VLANs is prepared. In case there are multiple switches on a network, the VLANs configured to each switch are determined and a list of configured VLANs for each switch is prepared.

In step 215, a VLAN is selected from the list of configured VLANs.

In step 220, state of the VLAN selected in step 215 is queried. This is determined by interrogating the switch. For example, in an embodiment involving a Cisco switch, a SNMP (Simple Network Management Protocol) request to the “VtpVlanState” MIB attribute of CISCO-VTP-MIB is made to determine the state of a VLAN.

In step 225, it is determined whether the state of the VLAN queried in step 220 is suspended. If the state of the VLAN queried is found to be suspended, the method moves to step 230. If the state of the VLAN queried is not found to be suspended, the method moves to step 235.

In step 230, the method returns to step 215, and iterates for another VLAN on the list, i.e. steps 220 and 225 are repeated for another VLAN configured to the switch.

In step 235, ports associated with the selected VLAN are determined and a list of associated ports is prepared. For example, in an embodiment involving a Cisco switch, the SNMP request to “vmVlan” MIB attribute of CISCO-VLAN-MEMBERSHIP-MIB is made to determine the ports associated with the selected VLAN.

In step 240, a port is selected from the list of associated ports.

In step 245, operational status of the selected port is queried.

In step 250, it is determined whether the operational status of the selected port is “up”. For example, in an embodiment involving a Cisco switch, the SNMP request to “ifOperStatus” MIB attribute of IF-MIB for every VLAN is used to determine the operational status of the selected port. If the operational status of the selected port is found to be “up”, the method moves to step 260. If the operational status of the selected port is not found to be “up”, the method moves to step 255.

In step 255, a determination is made whether the selected port is the last port on the associated ports list, i.e. whether end of the associated port list has been reached. If the selected port is not the last port on the associated ports list, the method moves to step 265. If the selected port is the last port on the associated ports list, the method moves to step 270.

In step 265, the method returns to step 240, and iterates for another port on the list, i.e. steps 245 and 250 are repeated for another associated port.

In step 260, status of the selected VLAN is defined, based on the operational status of the selected port. Once it has been determined (in step 250) that the operational status of the selected port is “up”, dynamic status of the selected VLAN is defined as “active”. In contrast, in step 270, once it has been determined (in step 250) that the operational status of the selected port is not “up”, and end of the associated port list has been reached, dynamic status of the selected VLAN is defined as “ignore”. Status of the selected VLAN is defined as operationally active if the operational status of at least one selected port is operationally up. Even if a single port from the selected VLAN is operationally “up” then the VLAN is deemed as “operationally active”. However, if all the participating ports of the VLAN are “operationally down”, the VLAN is deemed as “operationally inactive”

It would be appreciated that the method 100 updates a database with information concerning status of VLANs configured on a switch (or multiple switches). In the present embodiment, the “active” or “ignore” status of each VLAN configured on a switch is updated in a database, which may be associated with network management software. Further, the terms “active” or “ignore” have been used to indicate operational status of a VLAN configured on a switch, and other words, terms, marks, image, with similar or like meaning may also be used to indicate operational status of a VLAN without departing from the spirit of the invention.

Embodiments of the present invention provide a graphical user interface (GUI) displaying details related to status of one or more virtual local area networks. The details may also be provided in real time.

In step 275, it is determined whether end of the list of configured VLANs is reached. If the selected VLAN is the last VLAN among the VLANs configured to a switch, the method moves to step 280, else it returns to step 230, wherein the method iterates for another VLAN on the list, and steps 220 and 265 are repeated for another VLAN configured to the switch.

In step 280, based upon the status of one or more selected VLANs, a determination is made whether a community indexed VLAN for FDB (Forwarding Database) query succeeds for a single VLAN. If the status of one or more selected VLANs is operationally active and it has been determined (in step 275) that the selected VLAN is the last VLAN among the VLANs configured to a switch, the method checks whether a community indexed VLAN for FDB (Forwarding Database) query succeeds for a single VLAN from one of the “active” VLANs determined in step 260. In an embodiment involving a Cisco switch, to determine if the switch supports VLAN indexed FDB, a SNMP query is performed for any of the BRIDGE-MIB attributes on an “active” VLAN from the “active” VLANs obtained in step 260.

If the community indexed VLAN for FDB (Forwarding Database) query does not succeed for a single VLAN, the method ends in step 290. However, if the community indexed VLAN for FDB (Forwarding Database) query succeeds for a single VLAN, the method moves to step 285.

In step 285, FDB (Forwarding Database) ports for all the “active” VLANs are obtained to determine layer 2 connectivity. Embodiments of the present invention provide a graphical user interface (GUI) displaying details related to determined network topology (layer 2 of the OSI model details) and other network related details.

Embodiments of the present invention may be implemented in respect of switches manufactured by various companies, such as, but not limited to Cisco Systems, Inc.

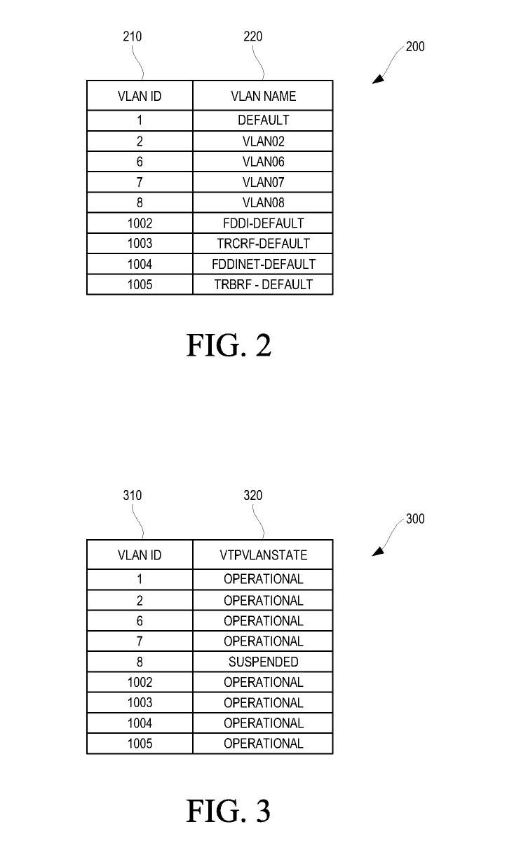

FIG. 2 shows an illustration of an exemplary graphical user interface (GUI) view 200 of a list of VLANs configured on a switch including default VLANs according to an embodiment. In an embodiment involving a Cisco switch, the list of VLANs configured on the switch including default VLANs is obtained by querying the vtpVlanName attribute of CISCO-VTP-MIB.

The view displays the VLAN IDs 210 and VLAN names 220. For example, the VLAN ID 1 is the “Default” VLAN. VLAN ID 2 is named VLAN02.

FIG. 3 shows an illustration of an exemplary graphical user interface (GUI) view 300 of query results for all the VLANs listed in FIG. 2 according to an embodiment. In an embodiment involving a Cisco switch, the vtpVlanState from CISCO-VTP-MIB is queried for all the VLANs listed in FIG. 2.

The view displays the VLAN IDs 310 and vtpVlanState 320. For example, for VLAN ID 1, the vtpVlanState is indicated as operational.

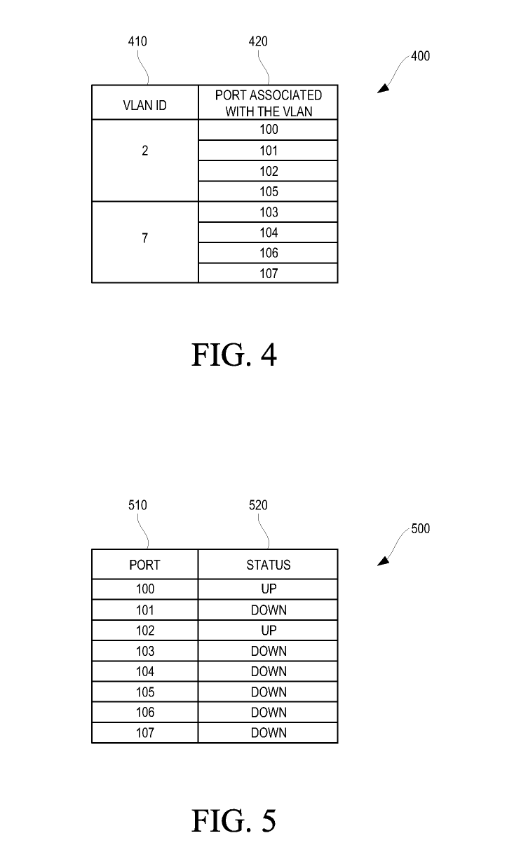

FIG. 4 shows an illustration of an exemplary graphical user interface (GUI) view 400 of port results for all the VLANs listed in FIG. 2 according to an embodiment. In an embodiment involving a Cisco switch, the ports corresponding to the VLANs listed in FIG. 2 are obtained using “vmVlan” attribute of CISCO-VLAN-MEMBERSHIP-MIB.

The view provides VLAN IDs 410 and port(s) associated with the VLAN. For example, VLAN ID 2 has ports 100, 101, 102 and 105 associated with it.

FIG. 5 shows an illustration of an exemplary graphical user interface (GUI) view 500 of query results on operational status for all the VLANs listed in FIG. 2 according to an embodiment. In an embodiment involving a Cisco switch, query results for all the VLANs listed in FIG. 2 are obtained by using the ifOperStatus attribute of IF-MIB for all “operationally up” ports associated with each VLAN.

The view provides a list of all “operationally up” ports 510 and their corresponding status 520. For example, port 100 is indicated having an “up” status, whereas port 101 is displayed as “down”.

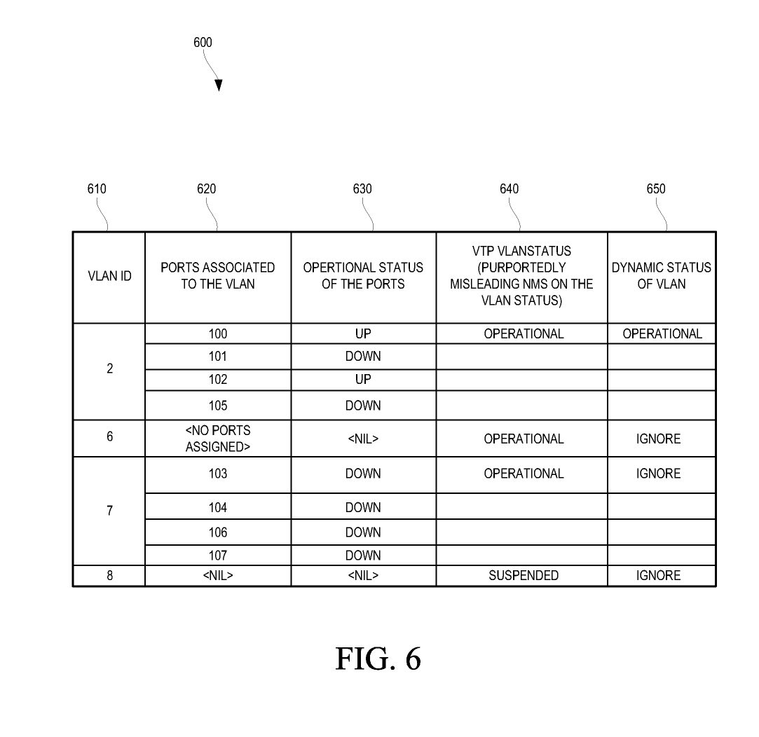

FIG. 6 shows an illustration of an exemplary graphical user interface (GUI) view 600 of a cross reference for all the MIB attributes of a user configured VLANs and the computation of dynamic status of VLAN to be used for determining layer 2 connectivity according to an embodiment.

The view provides a list of VLAN IDs 610, ports associated with a VLAN 620, operational status of the ports 630, vtp VlanStatus 640 and dynamic status of a VLAN 650 as determined by the embodiments of the present invention.

For example, for a VLAN with VLAN ID 2, ports 100, 101, 102 and 105 are the associated ports. The operational status of the associated ports is “up”, “down”, “up” and “down” respectively. The vtp VlanStatus of port 100 is “operational”, and the dynamic status of the VLAN (as determined by the embodiments of the present invention) is also “operational.”

FIG. 6 illustrates that the vtpVlanStatus may still be shown as operational for a VLANs, however from a from network management system's (NMS) standpoint, the dynamic status of VLAN (in last column) as computed by the embodiments of the present invention may be taken into consideration before performing an SNMP query of the instances of the BRIDGE-MIB for the specified VLANs and thereby obtaining efficient and accurate model to derive layer 2 connectivity information.

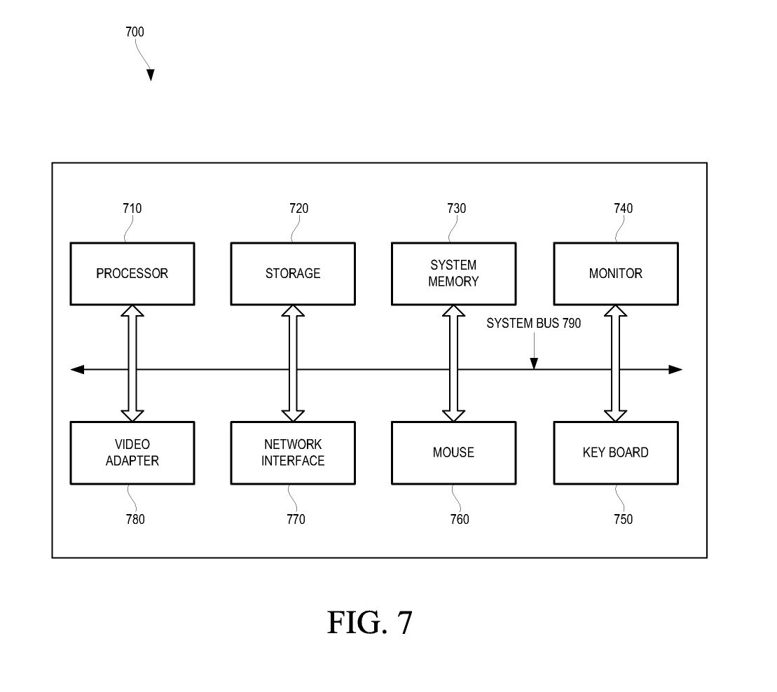

FIG. 7 shows a block diagram of a computer system 700 upon which an embodiment may be implemented. The computer system 700 includes a processor 710, a storage medium 720, a system memory 730, a monitor 740, a keyboard 750, a mouse 760, a network interface 770 and a video adapter 780. These components are coupled together through a system bus 790.

The storage medium 720 (such as a hard disk) stores a number of programs including an operating system, application programs and other program modules. A user may enter commands and information into the computer system 700 through input devices, such as a keyboard 750, a touch pad (not shown) and a mouse 760. The monitor 740 is used to display textual and graphical information.

An operating system runs on processor 710 and is used to coordinate and provide control of various components within personal computer system 700 in FIG. 7. Further, a Network Management System (NMS), such as, but not limited to, Network Node Manager (NNM) from Hewlett-Packard, may be used on the computer system 700 to implement the various embodiments described above.

It would be appreciated that the hardware components depicted in FIG. 7 are for the purpose of illustration only and the actual components may vary depending on the computing device deployed for implementation of the present invention. Further, the computer system 700 may be, for example, a desktop computer, a server computer, a laptop computer, or a wireless device such as a mobile phone, a personal digital assistant (PDA), a hand-held computer, etc.

The embodiment described provides an efficient way to compute the Layer 2 network topology connection by making use of dynamic status of VLAN derived by cross references to the attributes of different MIBs in a NMS. Since active dynamic status of a VLAN is chosen, the unwanted authentication traps are avoided and the SNMP query responses for VLAN indexed FDB is prompt.

It will be appreciated that the embodiments within the scope of the present invention may be implemented in the form of a computer program product including computer-executable instructions, such as program code, which may be run on any suitable computing environment in conjunction with a suitable operating system, such as, Microsoft Windows, Linux or UNIX operating system. Embodiments within the scope of the present invention may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present invention is for the purpose of illustration only. Although the invention has been described in conjunction with a specific embodiment thereof, those skilled in the art will appreciate that numerous modifications are possible without materially departing from the teachings and advantages of the subject matter described herein. Other substitutions, modifications and changes may be made without departing from the spirit of the present invention.

1. A computer-implemented method of determining network topology, the method comprising:
determining virtual local area networks (VLANs) configured to at least one switch on a computer network;
selecting a VLAN from the configured VLANs;
determining state of the selected VLAN;
determining ports associated with the selected VLAN, based upon the state of the selected VLAN;
selecting a port from the associated ports;
determining operational status of the selected port; and
defining status of the selected VLAN, based upon the operational status of the selected port.

2. A method according to claim 1, wherein the status of the selected VLAN is defined as operationally active if the operational status of at least one selected port is operationally up.

3. A method according to claim 2, further comprising providing a graphical user interface (GUI) displaying details related to status of one or more virtual local area networks.

4. A method according to claim 3, wherein the details related to status of one or more virtual local area networks is in real time.

5. A method according to claim 1, further comprising:
determining, based upon the status of one or more selected VLANs, whether a community indexed VLAN for FDB (Forwarding Database) query succeeds for at least one VLAN; and
obtaining FDB ports for all selected VLANs to determine network topology

6. A method according to claim 5, wherein the status of one or more selected VLANs is operationally active.

7. A method according to claim 5, further comprising providing a graphical user interface (GUI) displaying details related to determined network topology.

8. A method according to claim 5, wherein the network topology is layer 2 of the OSI model (Open System Interconnection Reference Model).

9. A method according to claim 1, wherein the ports associated with the selected VLAN are determined if the state of the selected VLAN is not suspended.

10. A method according to claim 1, further comprising:
selecting another VLAN from the configured VLANs, if the state of the selected VLAN is suspended; and
iterating the step of determining ports associated with the selected VLAN until a list of ports associated with each non suspended VLAN is obtained.

11. A method according to claim 1, further comprising:
selecting another port from the associated ports, if the operational status of the selected port is down; and
iterating the step of determining the operational status of all associated ports until a list of operationally up ports for each non suspended VLAN is obtained.

12. A method according to claim 1, wherein the state of the selected VLAN is determined by querying the switch.

13. A method according to claim 1, wherein the at least one switch is a Cisco switch.

14. A computer program comprising computer program means adapted to perform all of the steps of claim 1 when said program is run on a computer.

15. A computer program according to claim 14 embodied on a computer readable medium.
